(19) United States
(12) Patent Application Publication
(10) Pub. No.: US 2026/0233315 A1
(43) Pub. Date: Aug. 13, 2026

(54) CUTTING TOOL AND RELATED METHODS

(71) Applicant: Kennametal Inc., Latrobe, PA (US)

(72) Inventors: Evan J. Gruss, Greensburg, PA (US); Thomas P. Quatkemeyer, Troy, OH (US); Logan M. Semnisky, Greensburg, PA (US); John Brosnahan, North Huntingdon, PA (US)

(73) Assignee: Kennametal Inc., Latrobe, PA (US)

(21) Appl. No.: 19/048,239

(22) Filed: Feb. 7, 2025

(51) Int. Cl. B23C 5/28; B23C 5/10

(52) U.S. Cl. CPC B23C 5/28; B23C 5/10; B23C 2250/12

(57) ABSTRACT

A cutting tool includes a body have a first end and a second end opposite the first end. The second end can have one or more cutting elements positioned thereon adjacent to one or more fluid ejection ports positioned to facilitate injection of fluid out of the body and adjacent to the cutting elements. The first end can have a chamber defined therein that is in fluid communication with the one or more apertures via one or more conduits defined to extend from the chamber to the one or more ejection ports. In some embodiments, flutes can be defined adjacent a second end of the body and cutting elements can be positioned on or adjacent the flutes. At least some of the ejection ports can be positioned to emit coolant to cool the flutes and direct debris along the flutes away from the cutting elements.

### FIELD OF THE INVENTION

The present invention relates to a cutting tool and methods for making and using a cutting tool.

### BACKGROUND OF THE INVENTION

Examples of cutting tool assemblies can be found in U.S. Pat. Nos. 8,123,442, 8,637,127, 8,734,068, 8,807,888, 9,168,601, 10,195,678, and 11,420,273 and U.S. Patent Application Publication Nos. 2024109131, 2021/053128, 2020/0254545, 2020/0246889, and 2016/0263666. Cutting tool can be utilized to manipulate a workpiece to form a device or a component part, for example. Some cutting tools can be used in metalworking, for example. Some types of cutting tools can be stationary while other types of cutting tools can be moveable (e.g. rotatable, etc.).

### SUMMARY OF THE INVENTION

In some types of cutting applications, a cutting tool may be utilized to finish a hole formed in a workpiece. In some types of applications, debris (e.g. chips) can be directed into a casting void during cutting, which can result in the workpiece that is being formed not having a sufficiently formed or finished hole.

In other types of applications, a cutting tool (e.g. a reamer) can be utilized for hole finishing and may not be configured sufficiently to remove debris away from the workpiece being manipulated by the tool in a desired fashion. This type of technical problem can result in debris falling onto the workpiece or into a hole being finished, which can detract from the finishing of the hole or cause other problems.

We determined that tools that utilize cooling channels to help cool the tools during use can be adapted so that coolant fluid utilized to help keep the tool cool during use can also direct debris formed via operation of the cutting tool in a desired flow path away from a workpiece to help improve operations and improve the quality of cutting provided by a cutting tool. Embodiments can be configured so that coolant can be utilized to help remove chips from a workpiece that may become positioned on the tool during use so that the tool can be cleaned during use and the debris can be directed away from the workpiece along flutes of the cutting tool.

We have developed a cutting tool that can provide a higher performance coolant delivery that can also better assist in chip evacuation. Embodiments can provide improved coolant conduit flow path configurations that can provide higher performance coolant delivery to a tool, which can increase the productivity of the tool and significantly improve the quality of the cutting provided by the tool. Embodiments can be configured so that the coolant flow velocity and volume can be efficiently and effectively routed through the body of the cutting tool to provide multiple different functions (e.g. directing debris along flutes away from the workpiece while also cooling the cutting tool, etc.).

Embodiments may utilize different types of cooling fluid. For instance, a cooling fluid can include air, liquid water, a liquid solution that includes water, a refrigerant, oil, mineral oil, or other type of cooling fluid components. The cooling fluid can be a liquid, a gas, or mixture of liquid and gas.

We have surprisingly found that embodiments that utilize embodiments of our tool design can allow embodiments to be less costly to manufacture while also having substantially better coolant flow and chip removal features. Embodiments can permit a cutting tool to be utilized to provide improved manufacturing flexibility (e.g. by requiring less downtime and/or less re-working due to high quality cutting provided by the tool) in addition to having a lower capital cost that is more environmentally friendly (e.g. via use of less metal to form the tool, etc.).

A cutting tool can include a body comprised of carbide, tungsten carbide, cemented carbide, cemented tungsten carbide, tool steel, steel, or other suitable type of metal. The cutting tool can also include one or more cutting elements that can be attached to the body of the cutting tool so that each cutting element is integral with the body (e.g. brazed to the body, etc.). The cutting elements can be comprised of polycrystalline diamond (PCD), tungsten carbide, carbide material, or other suitable material. In some embodiments, the cutting elements can be composed of a material that is harder than the material of the body of the cutting tool. The body of the cutting tool can include a first end that has the one or more cutting elements positioned thereon. A second end of the body that is opposite the first end can include a chamber to receive a coolant fluid. The body can be formed to define multiple conduits that extends from the chamber to one or more coolant fluid ejection ports positioned adjacent to the one or more cutting elements and/or flutes adjacent to the one or more cutting elements to guide a flow of the coolant fluid from the chamber to the one or more ports for passing of the coolant fluid through the body and out the one or more ports The one or more ports can be defined to direct the fluid onto the outer surface of the body of the cutting tool to direct debris along the flutes to remove chips or other debris that may be formed during use of the tool.

In some embodiments, the conduit(s) can be defined to provide a smooth passageway for the fluid passed from the chamber to the one or more ports for example. We have found such a feature to help reduce resistance to the flow of coolant to provide improved flow of coolant fluid that can allow fluid to be ejected out of the one or more holes at a greater flow velocity.

In some embodiments, the first end of the cutting tool body can be shaped to have multiple flutes. Each cutting edge of the flute can have at least one cutting element positioned thereon (e.g. attached thereon via brazing, etc.). There can be at least one fluid ejection port defined adjacent the flutes so that fluid is output from the port to help fan chips formed via operation of the tool along the flutes so that the debris moves away from the workpiece being cut by the tool.

In a first aspect, a cutting tool can be provided. The cutting tool can include a body having a first end and a second end opposite the first end. The first end of the body can define a coolant fluid feed chamber that is in fluid communication with at least one outer conduit defined in the body. Each of the at least one outer conduit can include a coolant ejection port feed conduit segment positioned to fluidly connect a coolant ejection port defined adjacent to the second end of the body to the coolant fluid feed chamber. The body can have at least one flute. Each of the at least one flute can be being positioned adjacent to at least one cutting element attachable to the second end of the body.

In some embodiments, the body of the cutting tool can be comprised of metal, cemented carbide, cemented tungsten carbide, tool steel, steel, a ceramic material, a carbide material, or tungsten carbide material. In some embodiments, the body can be formed via an additive manufacturing process (e.g. a binder jet additive manufacturing process, etc.) to define the at least one outer conduit, the coolant fluid feed chamber and/or any other conduits that may be defined in the bod (e.g. a central conduit or inner conduit, etc.).

In a second aspect, the coolant ejection port feed conduit segment can be defined to include a tapered intake segment, an intermediate elbow conduit segment, and a tapered coolant ejection port conduit segment. The intermediate elbow conduit segment can be positioned between the tapered intake segment and the tapered coolant ejection port conduit segment. The tapered coolant ejection port conduit segment can be positioned between the intermediate elbow conduit segment and the coolant ejection port.

In some embodiments, the intermediate elbow conduit segment can be defined so that an intake end of the intermediate elbow conduit segment that is adjacent the tapered intake segment is smaller in width or diameter than a fluid output end of the intermediate elbow conduit segment that is adjacent the tapered coolant ejection port conduit segment.

In some embodiments, the intermediate elbow conduit segment can be curved or bent to guide coolant fluid along a path that has greater than 90° of curvature so the coolant fluid changes its flow direction from being directed toward the second end to being directed away from the second end. For example, the intermediate elbow conduit segment can be curved or bent to guide coolant fluid along a path that has greater than 90° of curvature and less than 180° of curvature so the coolant fluid changes its flow direction from being directed toward the second end to being directed away from the second end along a curved path defined by the intermediate elbow conduit segment. For example, the intermediate elbow conduit segment can be curved or bent to guide coolant fluid along a path that has greater than 100° of curvature and less than 170° of curvature or greater than 110° of curvature and less than 160° of curvature. Other suitable types of curved paths can also be defined via the intermediate elbow conduit segment (e.g. there can be a curvature of between 120° and 160° or a curvature of between 110° and 170°, etc.).

In a third aspect, the at least one outer conduit can include a first outer conduit and a second outer conduit and the body can also define an inner conduit between the first outer conduit and the second outer conduit within the body. The inner conduit can extend from the coolant fluid feed chamber to a projection of the second end of the body to fluidly connect the coolant fluid feed chamber to at least one projection port of the projection. In some embodiments, the coolant ejection port feed conduit segment of the first outer conduit can be positioned to fluidly connect a first coolant ejection port defined adjacent a first flute of the at least one flute to the coolant fluid feed chamber and the coolant ejection port feed conduit segment of the second outer conduit can be positioned to fluidly connect a second coolant ejection port defined adjacent a second flute of the at least one flute to the coolant fluid feed chamber.

In some embodiments, the coolant ejection port feed conduit segment of the first outer conduit can be defined to include a tapered intake segment, an intermediate elbow conduit segment, and a tapered coolant ejection port conduit segment such that the intermediate elbow conduit segment can be positioned between the tapered intake segment and the tapered coolant ejection port conduit segment. The tapered coolant ejection port conduit segment can be positioned between the intermediate elbow conduit segment and the first coolant ejection port. Also, the coolant ejection port feed conduit segment of the second outer conduit can be defined to include a tapered intake segment, an intermediate elbow conduit segment, and a tapered coolant ejection port conduit segment such that the intermediate elbow conduit segment of the coolant ejection port feed conduit segment of the second outer conduit is positioned between the tapered intake segment and the tapered coolant ejection port conduit segment of the coolant ejection port feed conduit segment of the second outer conduit and the tapered coolant ejection port conduit segment of the coolant ejection port feed conduit segment of the second outer conduit is positioned between the intermediate elbow conduit segment of the coolant ejection port feed conduit segment of the second outer conduit and the second coolant ejection port.

The intermediate elbow conduit segment of the coolant ejection port feed conduit segment of the first outer conduit can be defined so that an intake end of the intermediate elbow conduit segment of the coolant ejection port feed conduit segment of the first outer conduit that is adjacent the tapered intake segment of the coolant ejection port feed conduit segment of the first outer conduit is smaller in width or diameter than a fluid output end of the intermediate elbow conduit segment of the coolant ejection port feed conduit segment of the first outer conduit that is adjacent the tapered coolant ejection port conduit segment of the coolant ejection port feed conduit segment of the first outer conduit. The intermediate elbow conduit segment of the coolant ejection port feed conduit segment of the second outer conduit can also be defined so that an intake end of the intermediate elbow conduit segment of the coolant ejection port feed conduit segment of the second outer conduit that is adjacent the tapered intake segment of the coolant ejection port feed conduit segment of the second outer conduit is smaller in width or diameter than a fluid output end of the intermediate elbow conduit segment of the coolant ejection port feed conduit segment of the second outer conduit that is adjacent the tapered coolant ejection port conduit segment of the coolant ejection port feed conduit segment of the second outer conduit.

In some embodiments, the intermediate elbow conduit segment of the coolant ejection port feed conduit segment of the first outer conduit can be curved or bent to guide coolant fluid along a path that has greater than 90° and less than 180° of curvature so the coolant fluid changes its flow direction from being directed toward the second end to being directed away from the second end along a curved path defined by the intermediate elbow conduit segment of the coolant ejection port feed conduit segment of the first outer conduit. The intermediate elbow conduit segment of the coolant ejection port feed conduit segment of the second outer conduit can also be curved or bent to guide coolant fluid along a path that has greater than 90° and less than 180° of curvature so the coolant fluid changes its flow direction from being directed toward the second end to being directed away from the second end along a curved path defined by the intermediate elbow conduit segment of the coolant ejection port feed conduit segment of the second outer conduit. For example, the intermediate elbow conduit segments of the first outer conduit and of the second outer conduit can each be curved or bent to guide coolant fluid along a path that has greater than 100° of curvature and less than 170° of curvature or greater than 110° of curvature and less than 160° of curvature. Other suitable types of curved paths can also be defined via the intermediate elbow conduit segments of the first and second outer conduits (e.g. there can be a curvature of between 120° and 160° or a curvature of between 110° and 170°, etc.).

In a fourth aspect, the cutting tool can also include at least one guard positioned adjacent the at least one flute to define at least one channel between the at least one guard and the at least one flute.

In a fifth aspect, the cutting tool of the first aspect can include one or more features of the second aspect, third aspect, and/or fourth aspect. Yet other embodiments can also, or alternatively, include other features or elements. Examples of these other features or elements may be appreciated from the exemplary embodiments discussed herein.

In a sixth aspect, a process of making and/or using a cutting tool can be provided. The process can include forming a cutting tool or a body of a cutting tool.

For example, embodiments of the process can include forming a body of a cutting tool via an additive manufacturing process wherein the body includes a first end and a second end opposite the first end. The first end of the body can define a coolant fluid feed chamber that is in fluid communication with an inner conduit, a first outer conduit, and a second outer conduit defined in the body. The first outer conduit can include a coolant ejection port feed conduit segment positioned to fluidly connect a first coolant ejection port defined adjacent to the second end of the body to the coolant fluid feed chamber. The second outer conduit can include a coolant ejection port feed conduit segment positioned to fluidly connect a second coolant ejection port defined adjacent to the second end of the body to the coolant fluid feed chamber. The body can also have a first flute positioned adjacent to the first coolant ejection port and a second flute positioned adjacent to the second coolant ejection port.

In some embodiments, the body can also include the inner conduit such that the inner conduit can extend from the coolant fluid feed chamber to a projection of the second end of the body to fluidly connect the coolant fluid feed chamber to at least one projection port of the projection.

In some embodiments, the body can be comprised of metal, cemented carbide, cemented tungsten carbide, tool steel, steel, a ceramic material, a carbide material, or tungsten carbide material. In some embodiments, the body can be formed via a. a binder jet additive manufacturing process, a three dimensional additive manufacturing process, or other type of additive manufacturing process.

In a seventh aspect, the process can be implemented so that the coolant ejection port feed conduit segment of the first outer conduit is defined to include a tapered intake segment, an intermediate elbow conduit segment, and a tapered coolant ejection port conduit segment such that the intermediate elbow conduit segment being positioned between the tapered intake segment and the tapered coolant ejection port conduit segment, the tapered coolant ejection port conduit segment positioned between the intermediate elbow conduit segment and the first coolant ejection port. Also, the coolant ejection port feed conduit segment of the second outer conduit can be defined to include a tapered intake segment, an intermediate elbow conduit segment, and a tapered coolant ejection port conduit segment such that the intermediate elbow conduit segment of the coolant ejection port feed conduit segment of the second outer conduit is positioned between the tapered intake segment and the tapered coolant ejection port conduit segment of the coolant ejection port feed conduit segment of the second outer conduit and the tapered coolant ejection port conduit segment of the coolant ejection port feed conduit segment of the second outer conduit is positioned between the intermediate elbow conduit segment of the coolant ejection port feed conduit segment of the second outer conduit and the second coolant ejection port.

In some embodiments, the intermediate elbow conduit segment of the coolant ejection port feed conduit segment of the first outer conduit can be defined so that an intake end of the intermediate elbow conduit segment of the coolant ejection port feed conduit segment of the first outer conduit that is adjacent the tapered intake segment of the coolant ejection port feed conduit segment of the first outer conduit is smaller in width or diameter than a fluid output end of the intermediate elbow conduit segment of the coolant ejection port feed conduit segment of the first outer conduit that is adjacent the tapered coolant ejection port conduit segment of the coolant ejection port feed conduit segment of the first outer conduit. Also, the intermediate elbow conduit segment of the coolant ejection port feed conduit segment of the second outer conduit can be defined so that an intake end of the intermediate elbow conduit segment of the coolant ejection port feed conduit segment of the second outer conduit that is adjacent the tapered intake segment of the coolant ejection port feed conduit segment of the second outer conduit is smaller in width or diameter than a fluid output end of the intermediate elbow conduit segment of the coolant ejection port feed conduit segment of the second outer conduit that is adjacent the tapered coolant ejection port conduit segment of the coolant ejection port feed conduit segment of the second outer conduit.

In some embodiments, the body can be formed so that the intermediate elbow conduit segment of the coolant ejection port feed conduit segment of the first outer conduit is curved or bent to guide coolant fluid along a path that has greater than 90° and less than 180° of curvature so the coolant fluid changes its flow direction from being directed toward the second end to being directed away from the second end along a curved path defined by the intermediate elbow conduit segment of the coolant ejection port feed conduit segment of the first outer conduit. Also, the intermediate elbow conduit segment of the coolant ejection port feed conduit segment of the second outer conduit can be curved or bent to guide coolant fluid along a path that has greater than 90° and less than 180° of curvature so the coolant fluid changes its flow direction from being directed toward the second end to being directed away from the second end along a curved path defined by the intermediate elbow conduit segment of the coolant ejection port feed conduit segment of the second outer conduit.

In an eighth aspect, the process can also include other steps or features. For example, embodiments of the process can include attaching one or more cutting elements to the body adjacent to the first flute and attaching one or more cutting elements to the body adjacent to the second flute. Each cutting element can be comprised of a material that is harder than the material of the body. In some embodiments, each cutting element can be comprised of polycrystalline diamond (PCD) material, tungsten carbide material, or other suitable material.

As another example, the process can include feeding fluid into the coolant fluid feed chamber so that a first portion of the fluid is passed through the inner conduit, a second portion of the fluid is passed through the first outer conduit, and a third portion of the fluid is passed through the second outer conduit. In some embodiments, the process can also include ejecting the second portion of the fluid out of the first coolant ejection port such that the second portion of the fluid is output in a pre-selected fluid output direction that is directed away from the second end of the body and ejecting the third portion of the fluid out of the second coolant ejection port such that the third portion of the fluid is output in a pre-selected fluid output direction that is directed away from the second end of the body.

In some embodiments, the second portion of fluid can change a flow direction from passing from the first end toward the second end to passing in a direction away from the second end to the first coolant ejection port via passing along a curved path defined by an intermediate elbow conduit segment of the coolant ejection port feed conduit segment of the first outer conduit. Also, the third portion of fluid can change a flow direction from passing from the first end toward the second end to passing in a direction away from the second end to the second coolant ejection port via passing along a curved path defined by an intermediate elbow conduit segment of the coolant ejection port feed conduit segment of the second outer conduit.

In a ninth aspect, the process of the sixth aspect can include one or more features of the seventh aspect and/or eighth aspect. Yet other embodiments can also, or alternatively, include other features or elements. Examples of these other features or elements may be appreciated from the exemplary embodiments discussed herein.

These and other embodiments shall be described in more detail herein and in the drawings that show exemplary embodiments. Therefore, other details, objects, and advantages will become apparent as the following description of certain present preferred embodiments thereof and certain present preferred methods of practicing the same proceeds.

### BRIEF DESCRIPTION OF THE DRAWINGS

Exemplary embodiments of a cutting apparatus, a cutting tool, and methods of making and using the same are shown in the accompanying drawings. It should be appreciated that like reference numbers used in the drawings may identify like components.:

FIG. 1 is a perspective view of a first exemplary embodiment of a cutting apparatus 1 that includes a moveable tool holder 3 that can hold a cutting tool 5 and move the tool to cut a workpiece WP.

FIG. 2 is a perspective view of a first exemplary embodiment of the cutting tool 5.

FIG. 3 is an end view illustrating the first end 5a of the first exemplary embodiment of the cutting tool.

FIG. 4 is an end view illustrating the second end 5c of the first exemplary embodiment of the cutting tool 5. FIG. 4 also illustrates a cross-sectional line B-B and a cross-sectional line C-C.

FIG. 5 is an end view similar to FIG. 4 illustrating the second end 5c of the first exemplary embodiment of the cutting tool 5. FIG. 5 also illustrates a cross-sectional line D-D.

FIG. 6 is a cross-sectional view of the first exemplary embodiment of the cutting tool 5 taken along line C-C shown in FIG. 4. FIG. 6 also includes an enlarged view of a port feed conduit segment 10 positioned to feed coolant fluid to a coolant ejection port 5o positioned adjacent a flute 5f and at least one cutting element of the cutting tool 5.

FIG. 7 is a cross-sectional view of the first exemplary embodiment of the cutting tool 5 taken along line B-B shown in FIG. 4.

FIG. 8 is a cross-sectional view of the first exemplary embodiment of the cutting tool 5 taken along line D-D shown in FIG. 5.

FIG. 9 is a flow chart illustrating a first exemplary embodiment of a process for making and/or using an embodiment of the cutting tool.

### DESCRIPTION

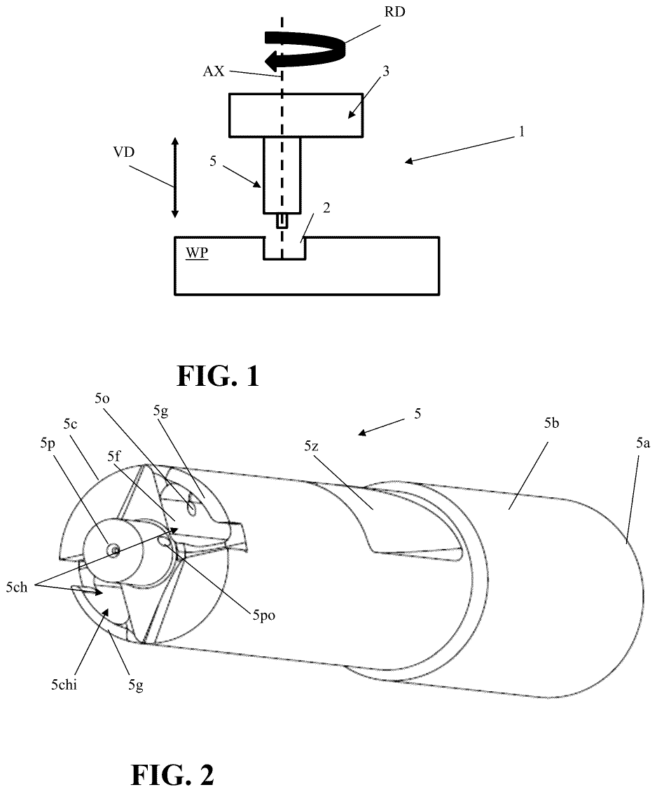

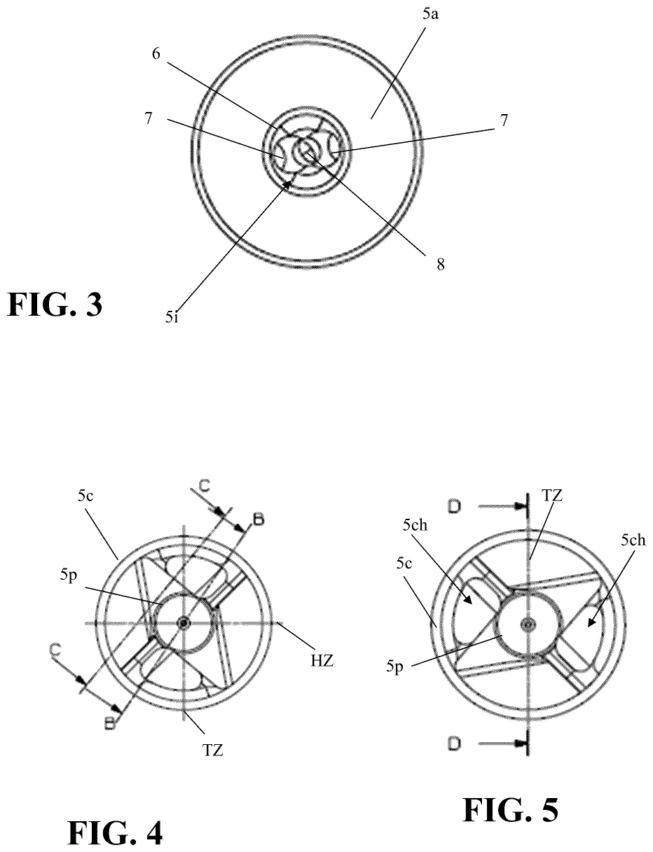

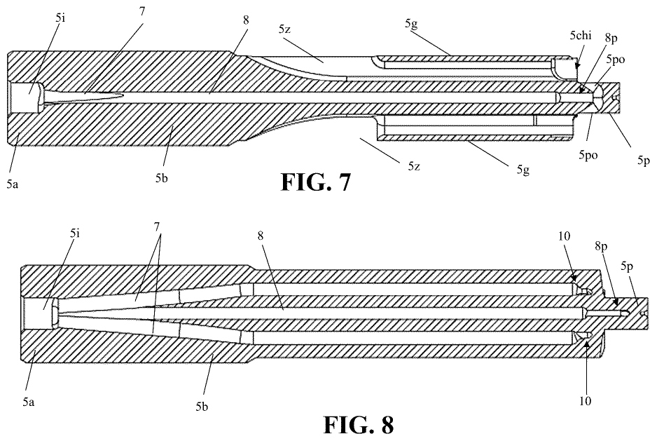

Referring to FIG. 1 through FIG. 8, a cutting apparatus 1 can include a tool holder 3 that is configured to hold a cutting tool 5. The cutting tool 5 can be moveable in a vertical direction VD such that the cutting tool can be lowered and raised. The cutting tool 5 can also be rotated in at least one rotational direction RD about an axis of rotation AX. The tool holder 3 can be configured to facilitate movement of the cutting tool 5 upwards, downwards, in a first rotational direction, and in a second rotational direction that is opposite the first rotational direction (e.g. in a clockwise direction and in a counterclockwise direction). In other embodiments, the cutting tool 5 may only be rotatable in a single rotational direction (e.g. clockwise or counterclockwise).

The cutting tool 5 can be moved adjacent to a workpiece WP to cut a workpiece. In some embodiments, the cutting tool 5 can be configured as a reamer or other type of finishing tool that may cut a workpiece adjacent an opening 2 defined in the workpiece to finish the opening to form a desired shaped and sized hole or other type of aperture in the workpiece. In other embodiments, the cutting tool 5 can be configured to cut an opening 2 into a workpiece or otherwise cut the workpiece to help shape the workpiece or define an aperture in the workpiece WP.

An exemplary embodiment of the cutting tool 5 can be seen in FIG. 2 through FIG. 8. The cutting tool 5 can include one or more cutting elements positioned adjacent different flutes 5f formed in the body 5b of the cutting tool adjacent a second end 5c of the body 5b that is opposite its first end 5a. The first end 5a can be positionable closest to a tool holder and the second end 5c can be a cutting end that can be positionable for engagement with a workpiece WP.

The second end 5c of the body 5b of the cutting tool 5 can include a projection 5p. The projection 5p can be positioned as a distal portion of the second end 5c and can include one or more projection ports 5po through which coolant fluid can be emitted. The coolant fluid can be output from the projection port(s) 5po to provide a flow of fluid adjacent the workpiece for directing fluid onto debris (e.g. chips) and the outer surfaces of the body 5b of the cutting tool to help cool the cutting tool 5 and to help direct debris away from the workpiece and toward the flutes 5f of the body 5b.

The flutes 5f can be defined on an outer surface of the body 5b adjacent to cutting elements that are positioned and configured to contact a workpiece to cut the workpiece WP. The cutting elements can be bodies comprised of a material that is harder than the material of the body (e.g. polycrystalline diamond (PCD) material, tungsten carbide material, etc.). The cutting elements can be brazed onto portions of the body 5b adjacent the flutes 5f so that the cutting elements are located between the flutes 5f and the second end 5c of the body 5b of the cutting tool 5, for example.

Each flute 5f defined on the body can be defined on an outer surface of the body 5b. In some embodiments, each of the flutes 5f can be covered at least partially by a guard 5g that can be positioned to define a channel 5ch through which debris can pass. Each defined channel 5ch can include an outlet 5z that is positioned closer to the first end 5a of the body as compared to the inlet of the channel 5ch defined adjacent to the cutting elements and/or the second end 5c of the body 5b. A respective guard 5g can be attached to the body 5b so the guard is positioned to cover a respective one of the flutes 5f to define a channel 5ch between the guard 5g and the flute 5f. Debris formed when the cutting tool 5 engages a workpiece WP can be passed into the channels 5ch via the channel inlets 5chi and the debris can then pass along the flutes 5f as the debris passes through the channels 5ch and can subsequently be output from the outlets 5z of the channels 5ch.

The body 5b can also include at least one coolant ejection port 5o defined adjacent a flute 5f or in a flute 5f. Each flute 5f can have at least one coolant ejection port 5o adjacent the channel inlet 5chi for embodiments that utilize a guard 5g to help partially enclose the flute 5f. Each coolant ejection port can be a circular, polygonal, or oval shaped opening through which coolant fluid may be ejected from within the body 5b and onto the flute 5f for contacting debris to help drive the debris into and/or through the channel 5ch and along the flute 5f for being output from the outlet 5z of the channel 5ch.

The distal projection 5p can also have one or more projection ports 5po defined therein to output fluid for contacting debris, the workpiece WP, and/or the body of the cutting tool 5 to cool the cutting tool and direct debris away from the workpiece. In some embodiments, the projection ports 5p can be defined to direct debris into the inlet 5chi of the channel 5ch while also contacting the body of the cutting tool to help cool the cutting tool 5. Each of the projection ports 5p can be a circular, polygonal, or oval shaped aperture through which coolant fluid may be ejected from within the projection 5p of the second end 5c of the body 5b.

The first end 5a of the body 5b of the cutting tool 5 can include a fluid feed chamber 5i defined in an inner portion 6 of the first end 5a of the body 5b. The fluid feed chamber 5i can be sized and configured to receive coolant fluid from a source of coolant fluid (e.g. a tank or reservoir etc. of coolant fluid). The fluid can be pumped into the fluid feed chamber 5i for being passed through the body 5b for being output from the projection ports 5po and the coolant ejection ports 5o positioned adjacent the flutes 5f and/or channel inlets chi. The fluid feed chamber 5i can be in fluid communication with an inner conduit 8 through which coolant fluid is passable for being output from the projection ports 5po defined in the projection 5p. The fluid feed chamber 5i can also be in fluid communication with side conduits 7 defined in the body 5b on opposite sides of the inner conduit 8 so that the inner conduit 8 is closer to a center of the body or in a center of the body and the outer conduits 7 are located closer to an outer surface of the body 5b of the cutting tool. Each of the outer conduits can be positioned to extend from the fluid feed chamber 5i to a respective one or more coolant ejection ports 5o defined adjacent to a flute 5f near or at a cutting end (e.g. the second end 5c) of the cutting tool (e.g. near projection 5p and/or channel inlet 5chi).

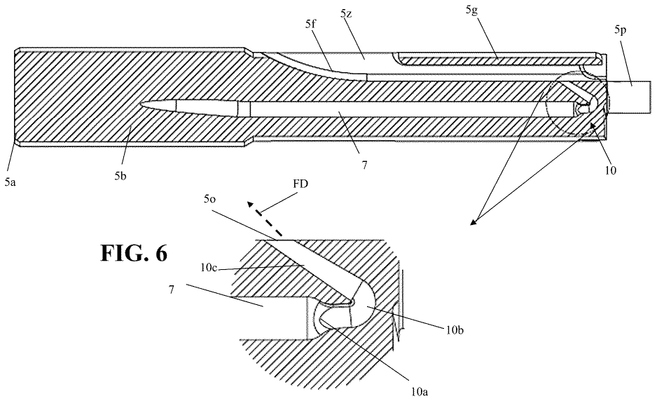

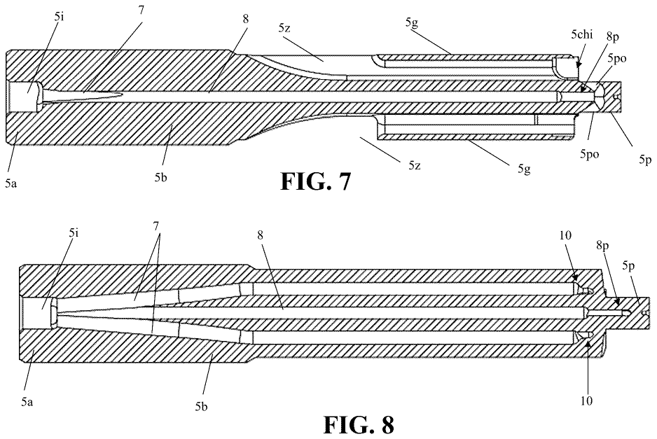

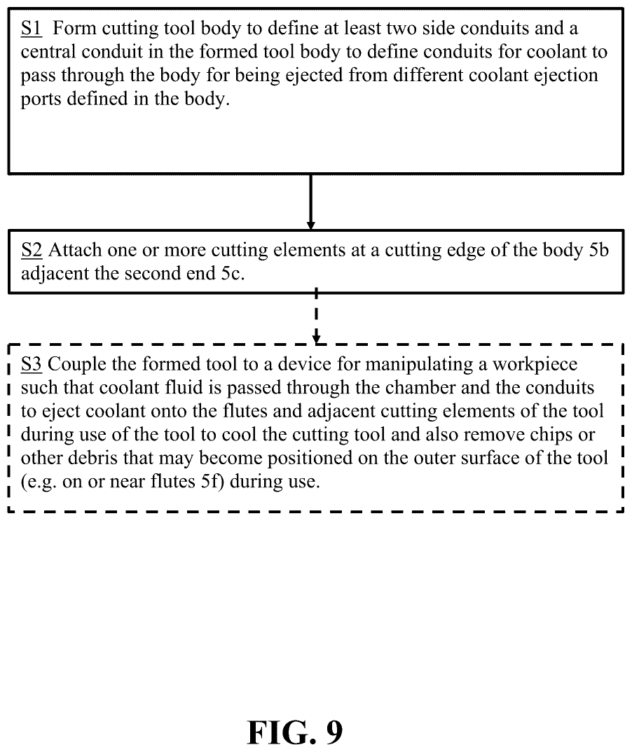

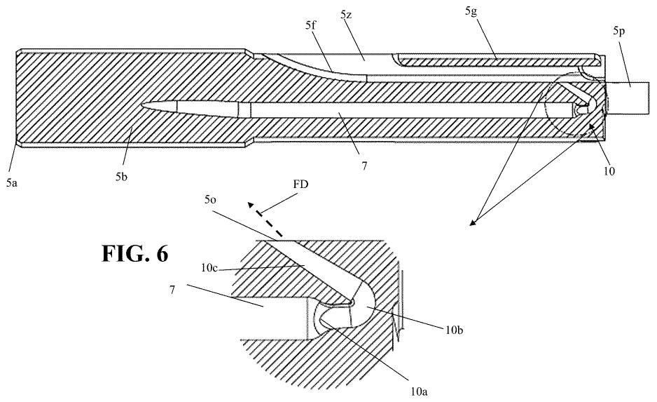

As may best be seen from FIG. 6 through FIG. 8, the outer conduits 7 and the inner conduit 8 can be defined to have smooth sidewalls to define a desired flow path for the coolant fluid through the body 5b of the cutting tool. The inner conduit 8 can extend from the fluid feed chamber 5i to a projection feed portion 8p of the inner conduit 8 defined in the projection 5p for feeding coolant fluid to projection ports 5po defined on opposite sides of the projection 5p adjacent different respective inlets 5chi of different channels 5ch defined by different flutes 5f of the body 5b.

Each of the outer conduits 7 can extend from the fluid feed chamber 5i to at least one coolant ejection port 5o defined in a respective flute 5f adjacent to the second end 5c of the body and/or the projection 5p of the body. In some embodiments, each outer conduit can extend to a coolant ejection port 5o positioned adjacent to the inlet 5chi of the channel 5ch defined to extend along a portion of the flute 5f., which can be adjacent the projection 5p and the second end 5c. Each outer conduit 7 can extend inside the body 5b along an outer side of the body.

For example, there can be a first outer conduit 7 and a second outer conduit 7. The inner conduit 8 can be between the first and second outer conduits 7. The first outer conduit 7 can be adjacent a left side of the body 5b and the second outer conduit can be adjacent a right side of the body 5b, for example. The first outer conduit 7 can extend to a first coolant ejection port 5o positioned adjacent to the inlet 5chi of a first channel 5ch defined adjacent to a first flute 5f of a first side of the body (e.g. a left side of the body 5b). The second outer conduit 7 can extend to a second coolant ejection port 5o positioned adjacent to the inlet 5chi of a second channel 5ch defined adjacent to a second flute 5f that is positioned on a second side of the body 5b opposite the first side of the body 5b having the first flute 5f.

Each outer conduit 7 can be defined to include a coolant ejection port feed conduit segment 10 positioned near or adjacent a second end 5c of the body opposite the fluid feed chamber 5i. The coolant ejection port feed conduit segment 10 can be shaped and defined so that fluid fed to the coolant ejection port(s) 5o to which the coolant ejection port feed conduit segment 10 is fluidly connected can feed fluid to the coolant ejection port(s) 5o so that the fluid is output in a fluid output direction FD that directs debris into the inlet 5chi of the channel 5ch and/or directs the debris away from the workpiece WP being cut (and the second end 5c) and toward the flute 5f of the coolant ejection port 5o so that the debris is passed along the flute 5f away from the second end 5c of the body and toward the first end 5a of the body (e.g. for being output from the outlet 5z of the channel 5ch for embodiments that utilize a guard 5g).

The coolant ejection port feed conduit segment 10 can be a portion of the outer conduit 7 between the inlet of the outer conduit 7 defined at an interface the outer conduit 7 has with the fluid feed chamber 5i and the coolant ejection port(s) 5o to which the outer conduit 7 is fluidly connected. The coolant ejection port feed conduit segment 10 can be defined to include a tapered intake segment 10a, an intermediate elbow conduit segment 10b, and a tapered coolant ejection port conduit segment 10c. The intermediate elbow conduit segment 10b can be positioned between the tapered intake segment 10a and the tapered coolant ejection port conduit segment 10c. The tapered coolant ejection port conduit segment 10c can be positioned between the intermediate elbow conduit segment 10b and the coolant ejection port(s) 5o to which the outer conduit 7 is fluidly connected. In some embodiments, the intermediate elbow conduit segment 10b can be defined so that its intake end adjacent the tapered intake segment 10a is smaller in width or diameter than its fluid output end adjacent the tapered coolant ejection port conduit segment 10c.

The tapered intake segment 10a can be defined and configured to utilize the Venturi effect to increase a velocity of the fluid for the fluid to be directed through the intermediate elbow conduit segment 10b. The intermediate elbow conduit segment 10b can be curved or bent to guide the coolant fluid along a path that is greater than 90 degrees of curvature (e.g. between over 90° and less than 180° of curvature, between 110° and 170° or between 120°and 160°). This type of guided path can cause the fluid to change its flow direction from being directed toward the second end 5c to being directed away from the second end 5c.

The tapered coolant ejection port conduit segment 10c can have a wider intake end adjacent the intermediate elbow conduit segment 10b and a narrower end in fluid communication with the coolant ejection port(s) 5o defined in the flute 5f to which the outer conduit 7 is fluidly connected. In some embodiments, the tapered coolant ejection port conduit segment 10c can taper continuously from its wider intake end to its narrower end in fluid communication with the coolant ejection port(s) 5o. For example, the tapered coolant ejection port conduit segment 10c can taper continuously and linearly from its wider intake end to its narrower end in fluid communication with the coolant ejection port(s) 5o in some embodiments. The tapering of the tapered coolant ejection port conduit segment 10c can help increase the velocity of the fluid passed to the coolant ejection port(s) 5o for being ejected toward the flute 5f in a fluid output direction FD that is directed toward the first end 5a of the body 5b and away from the second end 5c of the body 5.

In some embodiments, the body 5b of the cutting tool 5 can include a first outer conduit 7 that can include a first coolant ejection port feed conduit segment 10, which can be a portion of the first outer conduit 7 between the inlet of the first outer conduit 7 defined at an interface the first outer conduit 7 has with the fluid feed chamber 5i and the first coolant ejection port(s) 5o to which the first outer conduit 7 is fluidly connected. The body 5b of the cutting tool 5 can also include a second outer conduit 7 that can include a second coolant ejection port feed conduit segment 10, which can be a portion of the second outer conduit 7 between the inlet of the second outer conduit 7 defined at an interface the second outer conduit 7 has with the fluid feed chamber 5i and the second coolant ejection port(s) 5o to which the second outer conduit 7 is fluidly connected.

In some embodiments, the fluid feed chamber 5i can have an internal cross-sectional area of a volume for receipt and passage of coolant fluid. The inner conduit 8 can be sized to receive between 10% and 30% of the fluid fed to the fluid feed chamber 5i. For example, the inner conduit 8 can be sized to receive between 10% and 25% or between 10% and 20% of the fluid fed to the fluid feed chamber 5i. In embodiments that utilize first and second outer conduits 7, each outer conduit 7 can be sized and configured to receive between 35% and 45% of the fluid fed to the fluid feed chamber 5i (e.g. between 45% and 40% or between 45% and 37.5% of the fluid fed to the fluid feed chamber 5i).

In some embodiments, the cross-sectional area of each of the outer conduits 7 can be sized so that the cross-sectional area of the outer conduit 7 is significantly narrower at the outlet end of the tapered intake segment 10a of the coolant ejection port feed conduit segment 10 (e.g. the end of the tapered intake segment 10a that can interface with the intermediate elbow conduit segment 10b). In some embodiments, the outlet end of the tapered intake segment 10a of the coolant ejection port feed conduit segment 10 can be between 30% and 40% of the cross-sectional area of the end of the outer conduit 7 that interfaces with the fluid feed chamber 5i. The tapered coolant ejection port conduit segment 10c can be sized so that its narrower end in fluid communication with the coolant ejection port(s) 5o to which the tapered coolant ejection port conduit segment 10c is fluidly connected is between 10% and 20% smaller in cross-sectional area than the cross-sectional area of the end of the tapered intake segment 10a that can interface with the intermediate elbow conduit segment 10b. The tapered coolant ejection port conduit segment 10c can be sized so that its narrower end in fluid communication with the coolant ejection port(s) 5o to which the tapered coolant ejection port conduit segment 10c is fluidly connected is between 25% and 35% of the cross-sectional area than the cross-sectional area of the cross-sectional area of the end of the outer conduit 7 that interfaces with the fluid feed chamber 5i. This type of arrangement in cross-sectional area sizing for different conduit portions of the outer conduits 7 can help provide a desired flow path and velocity for the fluid so that the coolant fluid output from the coolant ejection ports 5o is output at a pre-selected fluid output direction FD and a pre-selected output velocity to facilitate the driving of debris away from the second end 5c and along the flutes 5f of the coolant ejection ports 5o for directing the debris toward the first end 5a of the body 5b of the cutting tool 5.

The body 5b can be comprised of a tungsten carbide material, a carbide material, a type of steel, a metal, a ceramic material, or other type of suitable material. In some embodiments, the body 5b can be formed via an additive manufacturing process to define the coolant ejection ports 5o, projection ports 5p, inner conduit 8, outer conduits 7, and fluid feed chamber 5i. The flutes 5f and optional guards 5g can also be defined during the additive manufacturing process that may be used to form the cutting tool body 5b so that the entire cutting tool 5 can be formed via an additive manufacturing process. For example, the cutting tool body 5b and/or cutting tool 5 can be formed via a binder jet manufacturing process to form the body 5b having the coolant ejection ports 5o, projection ports 5p, inner conduit 8, outer conduits 7, and fluid feed chamber 5i as well as the flutes 5f, projection 5p, and guards 5g. Other embodiments may not utilize any guards 5g or may utilize guards 5g that can be attached to the body 5b after the body 5b is formed via an additive manufacturing process.

FIG. 9 illustrates an exemplary process for making and/or using an exemplary embodiment of the cutting tool 5. For example, in a first step S1, a cutting tool body 5b can be formed to define at least two side conduits, which can be or include outer conduits 7, and a central conduit, which can be or include the inner conduit 8. These conduits can extend from a coolant fluid feed chamber 5i defined in a first end 5a of the body 5b. The inner conduit 8 can extend from the coolant fluid feed chamber 5i to projection ports 5po as noted above. Each of the side outer conduits 7 can extend from the coolant fluid feed chamber 5i to a respective coolant ejection port 5o defined adjacent a respective flute 5f adjacent the second end 5c of the body 5b as discussed above. The conduits can be defined to facilitate and guide a flow of coolant fluid through the body 5b for being ejected out of the body at different locations as discussed above. Each side outer conduit 7 can be defined to include a coolant ejection port feed conduit segment 10 as discussed above as well so that coolant fluid passed through the side conduits can be output from coolant ejection ports 5o in a pre-selected coolant output direction FD at a pre-selected velocity as discussed above. The forming of the body 5b in the first step S1 can be performed via an additive manufacturing process (e.g. 3D printing, binder jet printing, etc.).

In a second step S2, one or more cutting elements can be attached to the body 5b at cutting element positions adjacent the second end 5c of the body. Each cutting element can be brazed or otherwise affixed to a pre-selected location adjacent the second end 5c of the body adjacent the projection 5p and a respective one of the flutes 5f of the body 5, for example.

In an optional third step S3, the formed cutting tool 5 can be coupled to a device (e.g. tool holder 3) for moving the cutting tool 5 to manipulate a workpiece WP so that coolant fluid is passed through the fluid feed chamber 5i and passed through the inner conduit 8 and the outer conduits 7 simultaneously to eject the coolant fluid on to the flutes 5f and adjacent the cutting elements. The coolant fluid passed though the outer conduits 7 can pass through the coolant ejection port feed conduit segment 10 as discussed above as well so that coolant fluid passed through the side conduits can be output from coolant ejection ports 5o in a pre-selected coolant output direction FD at a pre-selected velocity as discussed above.

As coolant fluid is directed towards the flutes 5f, the cross-sectional area of the conduit through which the fluid may flow as it passes through the outer conduits 7 can be decreasing to increase velocity of the fluid. This type of increased velocity can occur as the coolant fluid passes through the ejection port feed conduit segment 10 of the outer conduit 7 for each outer conduit 7, for example. The velocity can increase initially as the fluid is passed through the tapered intake segment 10a. The pressure of the fluid may also decrease as the velocity is increased. The velocity may be similar or decrease as the fluid subsequently passes through the intermediate elbow conduit segment 10b. Then, the coolant fluid may again experience increased velocity as the fluid passes through the tapered coolant ejection port conduit segment 10c before it is output from the coolant ejection port(s) 5o to which the tapered coolant ejection port conduit segment 10c is connected in a pre-selected coolant output direction FD at a pre-selected velocity as discussed above. When the fluid increases in velocity, it may also decrease in pressure. As the fluid is passed through the intermediate elbow conduit segments 10b, the fluid can change direction from being passed toward the second end 5c of the cutting tool to being passed in a direction away from the second end 5c of the cutting tool at an angle relative to the rotational axis AX of the cutting tool 5.

The shape and configuration of the coolant ejection ports 5o and the projection ports 5po can be sized and configured to direct the coolant across the edges of the cutting elements and provide backflushing to direct chips onto the flutes 5f. For embodiments that utilize guards 5g to define channels 5ch to at least partially enclose the flutes 5f, the output of the coolant fluid can be pre-selected to drive the debris formed via rotation and/or motion of the cutting tool 5 while it engages a workpiece WP so that the debris is passed through the channels 5ch toward the first end 5a (and outlets 5z of the channels 5ch).

Embodiments of the process can also include other steps. For example, the cutting tool 1 may undergo cleaning, polishing, or other treatments as part of the fabrication process for forming the cutting tool 1. In conjunction with use of the formed cutting tool, the process can also include other steps in addition to the third step S3, such as providing coolant fluid and/or supplying coolant fluid to the cutting tool 5.

In some embodiments, the process can also include feeding fluid into the coolant fluid feed chamber 5i so that a first portion of the fluid is passed through the inner conduit 8, a second portion of the fluid is passed through the first outer conduit 7, and a third portion of the fluid is passed through the second outer conduit 7. The process can also include ejecting the second portion of the fluid out of the first coolant ejection port 5o such that the second portion of the fluid is output in a pre-selected fluid output direction FD that is directed away from the second end of the body and ejecting the third portion of the fluid out of the second coolant ejection port 5o such that the third portion of the fluid is output in a pre-selected fluid output direction FD that is directed away from the second end 5c of the body 5b. The second portion of fluid can change a flow direction from passing from the first end 5a toward the second end 5c to passing in a direction away from the second end 5c to the first coolant ejection port 5o via passing along a curved path defined by an intermediate elbow conduit segment 10b of the coolant ejection port feed conduit segment 10 of the first outer conduit 7. The third portion of fluid can also change a flow direction from passing from the first end 5a toward the second end 5c to passing in a direction away from the second end 5c to the second coolant ejection port 5o via passing along a curved path defined by an intermediate elbow conduit segment 10b of the coolant ejection port feed conduit segment 10 of the second outer conduit 7.

In some embodiments (e.g. as noted above), additive manufacturing can be utilized to help define the different conduits and the ejection port feed conduit segments 10 and the ports through which coolant fluid is output to help provide smooth conduit surfaces for guiding the flow of the fluid. The additive manufacturing process can also help permit the ejection port feed conduit segments 10 to direct the flow of fluid passing through the body 5b to change directions from passing from the first end 5a to the second end 5c so that the fluid changes direction to move in a direction that extends from the second end toward the first end 5a at an angle relative to the axis of rotation AX so that the pre-selected fluid direction FD of fluid output from the coolant ejection ports 5o can be moving in a direction toward the first end 5a at an angle relative to the axis of rotation.

In some embodiments of the cutting tool 5, the body 5b can define the coolant fluid feed chamber 5i that is in fluid communication with at least one outer conduit 7 defined in the body 5b. Each of the at least one outer conduit 7 can include a coolant ejection port feed conduit segment 10 positioned to fluidly connect a coolant ejection port 5o defined adjacent to the second end 5c of the body 5b to the coolant fluid feed chamber 5i. The coolant fluid feed chamber 5i can be defined in the first end 5a of the body 5b. The body 5b can have at least one flute 5f such that each of the at least one flute 5f is positioned adjacent to at least one cutting element attachable to the second end 5c of the body.

In some embodiments, the coolant ejection port feed conduit segment 10 for each outer conduit 7 can be defined to include a tapered intake segment 10a, an intermediate elbow conduit segment 10b, and a tapered coolant ejection port conduit segment 10c. The intermediate elbow conduit segment can be defined so that an intake end of the intermediate elbow conduit segment that is adjacent the tapered intake segment is smaller in width or diameter than a fluid output end of the intermediate elbow conduit segment that is adjacent the tapered coolant ejection port conduit segment. In some configurations, the intermediate elbow conduit segment 10b can be curved or bent to guide coolant fluid along a path that has greater than 90° of curvature so the coolant fluid changes its flow direction from being directed toward the second end to being directed away from the second end. For instance, in some embodiments, the intermediate elbow conduit segment 10b can be curved or bent to guide coolant fluid along a path that has greater than 90° and less than 180° of curvature so the coolant fluid changes its flow direction from being directed toward the second end 5c to being directed away from the second end 5c along a curved path defined by the intermediate elbow conduit segment.

In some embodiments the at least one outer conduit 7 includes a first outer conduit 7 and a second outer conduit 7 and the body 5b also defines an inner conduit 8 between the first outer conduit 7 and the second outer conduit 7 within the body 5b. The inner conduit 8 can extend from the coolant fluid feed chamber 5i to a projection 5p of the second end 5c of the body 5b to fluidly connect the coolant fluid feed chamber 5i to at least one projection port 5po of the projection 5p. The coolant ejection port feed conduit segment 10 of the first outer conduit 7 can be positioned to fluidly connect a first coolant ejection port 5o defined adjacent a first flute 5f of the at least one flute to the coolant fluid feed chamber 5i and the coolant ejection port feed conduit segment 10 of the second outer conduit 7 can be positioned to fluidly connect a second coolant ejection port 5o defined adjacent a second flute 5f of the at least one flute to the coolant fluid feed chamber 5i. The first and second flutes can be on opposite side of the body 5b in some embodiments (e.g. the first flute 5f can be on the first side of the body 5b and the second flute can be on a second side of the body 5b that is opposite the first side of the body 5b).

The coolant ejection port feed conduit segment 10 of the first outer conduit 7 can be defined to include a tapered intake segment 10a, an intermediate elbow conduit segment 10b, and a tapered coolant ejection port conduit segment 10c such that the intermediate elbow conduit segment 10b is positioned between the tapered intake segment 10a and the tapered coolant ejection port conduit segment 10c, The tapered coolant ejection port conduit segment 10c can be positioned between the intermediate elbow conduit segment 10b and the first coolant ejection port 5o. The coolant ejection port feed conduit segment 10 of the second outer conduit 7 can be defined to include a tapered intake segment 10a, an intermediate elbow conduit segment 10b, and a tapered coolant ejection port conduit segment 10c such that the intermediate elbow conduit segment 10b of the coolant ejection port feed conduit segment 10 of the second outer conduit 7 is positioned between the tapered intake segment 10a and the tapered coolant ejection port conduit segment 10c of the coolant ejection port feed conduit segment 10 of the second outer conduit 7. The tapered coolant ejection port conduit segment 10c of the coolant ejection port feed conduit segment 10 of the second outer conduit 10 can be positioned between the intermediate elbow conduit segment 10b of the coolant ejection port feed conduit segment 10 of the second outer conduit 7 and the second coolant ejection port 5o.

The intermediate elbow conduit segment 10b of the coolant ejection port feed conduit segment 10 of the first outer conduit 7 can be defined so that an intake end of the intermediate elbow conduit segment 10b of the coolant ejection port feed conduit segment 10 of the first outer conduit 7 that is adjacent the tapered intake segment 10a of the coolant ejection port feed conduit segment 10 of the first outer conduit 7 is smaller in width or diameter than a fluid output end of the intermediate elbow conduit segment 10b of the coolant ejection port feed conduit segment 10 of the first outer conduit 7 that is adjacent the tapered coolant ejection port conduit segment 10c of the coolant ejection port feed conduit segment 10 of the first outer conduit 7. The intermediate elbow conduit segment 10b of the coolant ejection port feed conduit segment 10 of the second outer conduit 7 is defined so that an intake end of the intermediate elbow conduit segment 10b of the coolant ejection port feed conduit segment 10 of the second outer conduit 7 that is adjacent the tapered intake segment 10a of the coolant ejection port feed conduit segment 10 of the second outer conduit 7 is smaller in width or diameter than a fluid output end of the intermediate elbow conduit segment 10b of the coolant ejection port feed conduit segment 10 of the second outer conduit 7 that is adjacent the tapered coolant ejection port conduit segment 10c of the coolant ejection port feed conduit segment 10 of the second outer conduit 7.

The intermediate elbow conduit segment 10b of the coolant ejection port feed conduit segment 10 of the first outer conduit 7 can be curved or bent to guide coolant fluid along a path that has greater than 90° and less than 180° of curvature so the coolant fluid changes its flow direction from being directed toward the second end to being directed away from the second end along a curved path defined by the intermediate elbow conduit segment 10b of the coolant ejection port feed conduit segment 10 of the first outer conduit 7. Also, the intermediate elbow conduit segment 10b of the coolant ejection port feed conduit segment 10 of the second outer conduit 7 can be curved or bent to guide coolant fluid along a path that has greater than 90° and less than 180° of curvature so the coolant fluid changes its flow direction from being directed toward the second end 5c to being directed away from the second end 5c along a curved path defined by the intermediate elbow conduit segment 10b of the coolant ejection port feed conduit segment 10 of the second outer conduit 7.

Embodiments can be configured so that the coolant ejection ports 5o can fan all chips or other debris made from the cutting elements of the cutting tool engaging a workpiece WP to be directed away from the second end 5c and toward the first end 5a along the flutes 5f (and when guards 5g are utilized, through the channels 5ch). The coolant ejection ports 5o can output fluid in the pre-selected fluid output direction FD to help drive pressure in the enclosed flutes 5f to create a venturi effect to pull chips up and out of the workpiece, for example. Even when the flutes are not enclosed via guards, the coolant ejection ports 5o can output fluid in the pre-selected fluid output direction FD to help drive debris away from the second end 5c of the body 5b and away from the work piece along the flutes 5f to move debris away from the workpiece WP to provide a higher quality cutting operation with a higher quality finish to the workpiece shaping performed by the cutting tool 5.

Further, the shaping of the different conduits and chamber for receipt and passage of coolant fluid through the body 5b can permit a cutting tool to be lighter weight in addition to providing higher quality cutting operations. The lighter weight structure can provide cost reduction for the cutting tool as well as provide improved operational performance via the guiding of coolant fluid through the body 5b.

It should be appreciated that the exemplary embodiments discussed herein can be adjusted to account for a particular set of design criteria. For example, the size and shape of the body, the size and shape of cutting elements, the size and shape of fluid conduit segments, and the type of materials utilized for the cutting tool 5 can be any of a number of different options. For instance, the type of material used for the body 5b (e.g. carbide, cemented carbine, tungsten carbide, steel, etc.) of the cutting tool 5 and the type of material used for the cutting elements (e.g. a carbide material, PCD, tungsten carbide, etc.) can be any of a number of suitable material (e.g. cubic boron nitride, ceramic material, other type of hard material, etc.). As another example, the shape of the body 5, flute(s) 5f, conduits 7, chamber 5i, projection 5p, or other elements can be adapted to meet a particular set of design criteria. Thus, while certain present preferred embodiments of the cutting tool and embodiments of methods for making and using the same have been shown and described above, it is to be distinctly understood that the invention is not limited thereto but may be otherwise variously embodied and practiced within the scope of the following claims.

What is claimed is:

1. A cutting tool comprising:
a body having a first end and a second end opposite the first end, the first end of the body defining a coolant fluid feed chamber that is in fluid communication with at least one outer conduit defined in the body, each of the at least one outer conduit including a coolant ejection port feed conduit segment positioned to fluidly connect a coolant ejection port defined adjacent to the second end of the body to the coolant fluid feed chamber;
the body having at least one flute, each of the at least one flute being positioned adjacent to at least one cutting element attachable to the second end of the body.

2. The cutting tool of claim 1, wherein the coolant ejection port feed conduit segment is defined to include a tapered intake segment, an intermediate elbow conduit segment, and a tapered coolant ejection port conduit segment, the intermediate elbow conduit segment being positioned between the tapered intake segment and the tapered coolant ejection port conduit segment, the tapered coolant ejection port conduit segment positioned between the intermediate elbow conduit segment and the coolant ejection port.

3. The cutting tool of claim 2, wherein the intermediate elbow conduit segment is defined so that an intake end of the intermediate elbow conduit segment that is adjacent the tapered intake segment is smaller in width or diameter than a fluid output end of the intermediate elbow conduit segment that is adjacent the tapered coolant ejection port conduit segment.

4. The cutting tool of claim 2, wherein the intermediate elbow conduit segment is curved or bent to guide coolant fluid along a path that has greater than 90° of curvature so the coolant fluid changes its flow direction from being directed toward the second end to being directed away from the second end.

5. The cutting tool of claim 2, wherein the intermediate elbow conduit segment is curved or bent to guide coolant fluid along a path that has greater than 90° and less than 180° of curvature so the coolant fluid changes its flow direction from being directed toward the second end to being directed away from the second end along a curved path defined by the intermediate elbow conduit segment.

6. The cutting tool of claim 1, wherein the at least one outer conduit includes a first outer conduit and a second outer conduit and the body also defines an inner conduit between the first outer conduit and the second outer conduit within the body, the inner conduit extending from the coolant fluid feed chamber to a projection of the second end of the body to fluidly connect the coolant fluid feed chamber to at least one projection port of the projection.

7. The cutting tool of claim 6, wherein:
the coolant ejection port feed conduit segment of the first outer conduit is positioned to fluidly connect a first coolant ejection port defined adjacent a first flute of the at least one flute to the coolant fluid feed chamber; and
the coolant ejection port feed conduit segment of the second outer conduit is positioned to fluidly connect a second coolant ejection port defined adjacent a second flute of the at least one flute to the coolant fluid feed chamber.

8. The cutting tool of claim 7, wherein:
the coolant ejection port feed conduit segment of the first outer conduit is defined to include a tapered intake segment, an intermediate elbow conduit segment, and a tapered coolant ejection port conduit segment such that the intermediate elbow conduit segment being positioned between the tapered intake segment and the tapered coolant ejection port conduit segment, the tapered coolant ejection port conduit segment positioned between the intermediate elbow conduit segment and the first coolant ejection port; and
the coolant ejection port feed conduit segment of the second outer conduit is defined to include a tapered intake segment, an intermediate elbow conduit segment, and a tapered coolant ejection port conduit segment such that the intermediate elbow conduit segment of the coolant ejection port feed conduit segment of the second outer conduit is positioned between the tapered intake segment and the tapered coolant ejection port conduit segment of the coolant ejection port feed conduit segment of the second outer conduit and the tapered coolant ejection port conduit segment of the coolant ejection port feed conduit segment of the second outer conduit is positioned between the intermediate elbow conduit segment of the coolant ejection port feed conduit segment of the second outer conduit and the second coolant ejection port.

9. The cutting tool of claim 8, wherein:
the intermediate elbow conduit segment of the coolant ejection port feed conduit segment of the first outer conduit is defined so that an intake end of the intermediate elbow conduit segment of the coolant ejection port feed conduit segment of the first outer conduit that is adjacent the tapered intake segment of the coolant ejection port feed conduit segment of the first outer conduit is smaller in width or diameter than a fluid output end of the intermediate elbow conduit segment of the coolant ejection port feed conduit segment of the first outer conduit that is adjacent the tapered coolant ejection port conduit segment of the coolant ejection port feed conduit segment of the first outer conduit; and
the intermediate elbow conduit segment of the coolant ejection port feed conduit segment of the second outer conduit is defined so that an intake end of the intermediate elbow conduit segment of the coolant ejection port feed conduit segment of the second outer conduit that is adjacent the tapered intake segment of the coolant ejection port feed conduit segment of the second outer conduit is smaller in width or diameter than a fluid output end of the intermediate elbow conduit segment of the coolant ejection port feed conduit segment of the second outer conduit that is adjacent the tapered coolant ejection port conduit segment of the coolant ejection port feed conduit segment of the second outer conduit.

10. The cutting tool of claim 9, wherein:
the intermediate elbow conduit segment of the coolant ejection port feed conduit segment of the first outer conduit is curved or bent to guide coolant fluid along a path that has greater than 90° and less than 180° of curvature so the coolant fluid changes its flow direction from being directed toward the second end to being directed away from the second end along a curved path defined by the intermediate elbow conduit segment of the coolant ejection port feed conduit segment of the first outer conduit; and
the intermediate elbow conduit segment of the coolant ejection port feed conduit segment of the second outer conduit is curved or bent to guide coolant fluid along a path that has greater than 90° and less than 180° of curvature so the coolant fluid changes its flow direction from being directed toward the second end to being directed away from the second end along a curved path defined by the intermediate elbow conduit segment of the coolant ejection port feed conduit segment of the second outer conduit.

11. The cutting tool of claim 1, comprising at least one guard positioned adjacent the at least one flute to define at least one channel between the at least one guard and the at least one flute.

12. The cutting tool of claim 1, wherein the body is formed via an additive manufacturing process to define the coolant fluid feed chamber and the at least one outer conduit defined in the body.

13. A process of making and/or using a cutting tool, comprising:
forming a body of a cutting tool via an additive manufacturing process, the body having:
a first end and a second end opposite the first end, the first end of the body defining a coolant fluid feed chamber that is in fluid communication with an inner conduit, a first outer conduit, and a second outer conduit defined in the body, the first outer conduit including a coolant ejection port feed conduit segment positioned to fluidly connect a first coolant ejection port defined adjacent to the second end of the body to the coolant fluid feed chamber, the second outer conduit including a coolant ejection port feed conduit segment positioned to fluidly connect a second coolant ejection port defined adjacent to the second end of the body to the coolant fluid feed chamber;
the body having a first flute positioned adjacent to the first coolant ejection port and a second flute positioned adjacent to the second coolant ejection port.

14. The process of claim 13, wherein:
the coolant ejection port feed conduit segment of the first outer conduit is defined to include a tapered intake segment, an intermediate elbow conduit segment, and a tapered coolant ejection port conduit segment such that the intermediate elbow conduit segment being positioned between the tapered intake segment and the tapered coolant ejection port conduit segment, the tapered coolant ejection port conduit segment positioned between the intermediate elbow conduit segment and the first coolant ejection port; and
the coolant ejection port feed conduit segment of the second outer conduit is defined to include a tapered intake segment, an intermediate elbow conduit segment, and a tapered coolant ejection port conduit segment such that the intermediate elbow conduit segment of the coolant ejection port feed conduit segment of the second outer conduit is positioned between the tapered intake segment and the tapered coolant ejection port conduit segment of the coolant ejection port feed conduit segment of the second outer conduit and the tapered coolant ejection port conduit segment of the coolant ejection port feed conduit segment of the second outer conduit is positioned between the intermediate elbow conduit segment of the coolant ejection port feed conduit segment of the second outer conduit and the second coolant ejection port.

15. The process of claim 14, wherein:
the intermediate elbow conduit segment of the coolant ejection port feed conduit segment of the first outer conduit is defined so that an intake end of the intermediate elbow conduit segment of the coolant ejection port feed conduit segment of the first outer conduit that is adjacent the tapered intake segment of the coolant ejection port feed conduit segment of the first outer conduit is smaller in width or diameter than a fluid output end of the intermediate elbow conduit segment of the coolant ejection port feed conduit segment of the first outer conduit that is adjacent the tapered coolant ejection port conduit segment of the coolant ejection port feed conduit segment of the first outer conduit; and
the intermediate elbow conduit segment of the coolant ejection port feed conduit segment of the second outer conduit is defined so that an intake end of the intermediate elbow conduit segment of the coolant ejection port feed conduit segment of the second outer conduit that is adjacent the tapered intake segment of the coolant ejection port feed conduit segment of the second outer conduit is smaller in width or diameter than a fluid output end of the intermediate elbow conduit segment of the coolant ejection port feed conduit segment of the second outer conduit that is adjacent the tapered coolant ejection port conduit segment of the coolant ejection port feed conduit segment of the second outer conduit.

16. The process of claim 15, wherein:
the intermediate elbow conduit segment of the coolant ejection port feed conduit segment of the first outer conduit is curved or bent to guide coolant fluid along a path that has greater than 90° and less than 180° of curvature so the coolant fluid changes its flow direction from being directed toward the second end to being directed away from the second end along a curved path defined by the intermediate elbow conduit segment of the coolant ejection port feed conduit segment of the first outer conduit; and
the intermediate elbow conduit segment of the coolant ejection port feed conduit segment of the second outer conduit is curved or bent to guide coolant fluid along a path that has greater than 90° and less than 180° of curvature so the coolant fluid changes its flow direction from being directed toward the second end to being directed away from the second end along a curved path defined by the intermediate elbow conduit segment of the coolant ejection port feed conduit segment of the second outer conduit.

17. The process of claim 13, comprising:
attaching one or more cutting elements to the body adjacent to the first flute; and
attaching one or more cutting elements to the body adjacent to the second flute.

18. The process of claim 13, comprising:
feeding fluid into the coolant fluid feed chamber so that a first portion of the fluid is passed through the inner conduit, a second portion of the fluid is passed through the first outer conduit, and a third portion of the fluid is passed through the second outer conduit.

19. The process of claim 18, comprising:
ejecting the second portion of the fluid out of the first coolant ejection port such that the second portion of the fluid is output in a pre-selected fluid output direction that is directed away from the second end of the body and ejecting the third portion of the fluid out of the second coolant ejection port such that the third portion of the fluid is output in a pre-selected fluid output direction that is directed away from the second end of the body.

20. The process of claim 19, wherein:
the second portion of fluid changes a flow direction from passing from the first end toward the second end to passing in a direction away from the second end to the first coolant ejection port via passing along a curved path defined by an intermediate elbow conduit segment of the coolant ejection port feed conduit segment of the first outer conduit; and
the third portion of fluid changes a flow direction from passing from the first end toward the second end to passing in a direction away from the second end to the second coolant ejection port via passing along a curved path defined by an intermediate elbow conduit segment of the coolant ejection port feed conduit segment of the second outer conduit.
